(19) United States
(12) Patent Application Publication
(10) Pub. No.: US 2024/0301581 A1
(43) Pub. Date: Sep. 12, 2024

(54) LIGHTFASTNESS IMPROVER FOR ANODIC OXIDE FILM OF DYED ALUMINUM OR ALUMINUM ALLOY AND METHOD FOR IMPROVING LIGHTFASTNESS OF FILM

(71) Applicant: OKUNO CHEMICAL INDUSTRIES CO., LTD., Osaka-shi, Osaka (JP)

(72) Inventors: Tomo Moriguchi, Osaka-shi, Osaka (JP); Ayumi Hongo, Osaka-shi, Osaka (JP); Toku Yasuda, Osaka-shi, Osaka (JP); Kentaro Hirai, Osaka-shi, Osaka (JP); Katsuyuki Tanaka, Osaka-shi, Osaka (JP); Kenji Hara, Osaka-shi, Osaka (JP)

(73) Assignee: OKUNO CHEMICAL INDUSTRIES CO., LTD., Osaka-shi, Osaka (JP)

(21) Appl. No.: 18/278,964

(22) PCT Filed: Mar. 3, 2022
(86) PCT No.: PCT/JP2022/009055

§ 371 Date: Aug. 25, 2023

(30) Foreign Application Priority Data
Mar. 5, 2021 (JP) 2021-035712

(51) Int. Cl. C25D 11/18

(52) U.S. Cl. CPC C25D 11/18

(57) ABSTRACT

An object of the present invention is to provide a technique for improving the lightfastness of a dyed anodic oxide film of aluminum or an aluminum alloy. Provided are a Lightfastness improver for a dyed anodic oxide film of aluminum or an aluminum alloy, and a method for improving the Lightfastness of the film.

### TECHNICAL FIELD

The present invention relates to a lightfastness improver for a dyed anodic oxide film of aluminum or an aluminum alloy, and a method for improving the lightfastness of the film.

### BACKGROUND ART

Anodic oxide films are formed on light metals, such as aluminum or aluminum alloys, and the light metals with the anodic oxide films formed thereon are used for various applications. Such an anodic oxide film formed on aluminum or the like is dyed (colored) with a dye, such as an organic dye, depending on the application. When the anodic oxide film is dyed with a dye and then exposed to light, such as ultraviolet rays, there may be problems that the color (hue) of the dye changes, for example, the color of the dye becomes lighter and fades.

From the viewpoint of suppressing discoloration of a film, such as an anodic oxide film of a light metal, such as aluminum or an aluminum alloy, that has been dyed with a dye, and maintaining designability, a surface treatment technique capable of improving lightfastness is required.

Further, in recent years, from the viewpoint of reducing the use of environmentally hazardous substances, there has been a demand for surface treatment techniques that do not include a halogen compound, nitric acid nitrogen, or the like.

PTL 1 discloses a method for impregnating a surface formed by an anode of aluminum and/or an aluminum alloy, the method comprising bringing the colored or uncolored surface into contact with an aqueous solution containing one or more of an anionic surfactant compounds containing at least one of a sulfonic acid group, a phosphonic acid group and/or a phosphonous acid group.

As a technique capable of imparting excellent dyeing fastness to a dyed anodic oxide film of aluminum or an aluminum alloy, suppressing discoloration of the anodic oxide film when irradiated with light, and exhibiting excellent lightfastness, the present applicant has developed a surface treatment agent for a dyed anodic oxide film of aluminum or an aluminum alloy, containing a zirconium fluoride salt and having a pH of 3.4 or less (PTL 2).

### CITATION LIST

### Patent Literature

PTL 1: JPH04-502647A
PTL 2: JP6490878B

### SUMMARY OF INVENTION

### Technical Problem

An object of the present invention is to provide a novel technique for improving the lightfastness of a dyed anodic oxide film of aluminum or an aluminum alloy.

### Solution to Problem

The present inventors have conducted extensive research to achieve the above object. As a result, the present inventors have found that the use of phosphate or a surface treatment agent containing a chelating agent containing phosphorus in the structure favorably improves lightfastness, and thus have completed the present invention.

Specifically, the present invention relates to the following technique for improving lightfastness.

### Item 1.

A lightfastness improver for a film,
the film being a dyed anodic oxide film of aluminum or an aluminum alloy, and
the lightfastness improver comprising at least one phosphorus compound selected from the group consisting of a phosphoric acid, a phosphate, and a chelating agent containing phosphorus.

### Item 2.

The lightfastness improver according to Item 1, wherein the phosphoric acid is at least one phosphoric acid selected from the group consisting of phosphoric acid, phosphorous acid, and hypophosphorous acid.

### Item 3.

The lightfastness improver according to Item 1, wherein the phosphate is at least one salt selected from the group consisting of a sodium salt, a potassium salt, an ammonium salt, an alkaline earth metal salt, and a metal salt of at least one phosphoric acid selected from the group consisting of phosphoric acid, phosphorous acid, and hypophosphorous acid.

### Item 4.

The lightfastness improver according to Item 1, wherein the chelating agent containing phosphorus is at least one chelating agent selected from the group consisting of an inorganic chelating agent and an organic chelating agent.

### Item 5.

The lightfastness improver according to any one of Items 1 to 4, wherein the phosphorus compound is contained in an amount of 1 mg/L to 5,000 mg/L.

### Item 6.

The lightfastness improver according to any one of Items 1 to 5, further comprising a dye.

### Item 7.

The lightfastness improver according to any one of Items 1 to 5, which is a pretreatment agent for dyeing using a dye.

### Item 8.

The lightfastness improver according to any one of Items 1 to 5, which is a post-treatment agent for dyeing using a dye.

### Item 9.

The lightfastness improver according to any one of Items 6 to 8, wherein the dye is an organic dye.

### Item 10.

A method for improving the lightfastness of a film, the film being a dyed anodic oxide film of aluminum or an aluminum alloy, and the method comprising:

(1) immersing the film in a lightfastness improver comprising at least one phosphorus compound selected from the group consisting of a phosphoric acid, a phosphate, and a chelating agent containing phosphorus.

### Item 11.

A method for improving the lightfastness of a film, the film being a dyed anodic oxide film of aluminum or an aluminum alloy, and the method comprising:

(1) immersing the film in a lightfastness improver comprising at least one phosphorus compound selected from the group consisting of a phosphoric acid, a phosphate, and a chelating agent containing phosphorus, and further comprising a dye.

### Item 12.

A method for improving the lightfastness of a film, the film being a dyed anodic oxide film of aluminum or an aluminum alloy, and the method comprising:

(1) immersing the film in a lightfastness improver comprising at least one phosphorus compound selected from the group consisting of a phosphoric acid, a phosphate, and a chelating agent containing phosphorus; and

(2) dyeing the film obtained in step (1).

### Item 13.

A method for improving the lightfastness of a film, the film being a dyed anodic oxide film of aluminum or an aluminum alloy, and the method comprising:

(1) dyeing the film; and

(2) immersing the film obtained in step (1) in a lightfastness improver comprising at least one phosphorus compound selected from the group consisting of a phosphoric acid, a phosphate, and a chelating agent containing phosphorus.

### Advantageous Effects of Invention

The present invention can provide a technique for improving the lightfastness of a dyed anodic oxide film of aluminum or an aluminum alloy.

### DESCRIPTION OF EMBODIMENTS

The present invention is described in detail below.

### (1) Lightfastness Improver for Film

The present invention is a lightfastness improver for a film.

In the present invention, the film is a dyed anodic oxide film of aluminum or an aluminum alloy.

The lightfastness improver for a film of the present invention (also referred to simply as the “lightfastness improver”) comprises at least one phosphorus compound selected from the group consisting of a phosphoric acid, a phosphate, and a chelating agent containing phosphorus.

The use of the lightfastness improver of the present invention can improve the lightfastness of the film as surface treatment of the film.

According to the present invention, since the lightfastness of the film can be improved, the surface treatment is preferably followed by sealing treatment, whereby discoloration of the film after sealing treatment when irradiated with light can be suppressed, and excellent lightfastness can be exhibited.

According to the present invention, since the lightfastness of the film can be improved and sealing treatment is preferably performed, discoloration of the film of the obtained article when irradiated with light can be suppressed, and the article can exhibit excellent lightfastness.

The dyeing is preferably dyeing with an organic dye.

The present invention is a surface treatment technique capable of suppressing discoloration of a film, such as an anodic oxide film of a light metal, such as aluminum or an aluminum alloy, that has been subjected to dyeing treatment with a dye, improving lightfastness, and maintaining designability. The present invention is a surface treatment method that does not necessarily include a halogen compound, nitric acid nitrogen, or the like, and is a surface treatment technique that can reduce the use of environmentally hazardous substances.

### Phosphoric Acid and Phosphate

The phosphoric acid contained in the lightfastness improver of the present invention is preferably at least one phosphoric acid selected from the group consisting of phosphoric acid, phosphorous acid, and hypophosphorous acid.

The phosphate contained in the lightfastness improver of the present invention is preferably at least one salt selected from the group consisting of a sodium salt, a potassium salt, an ammonium salt, an alkaline earth metal salt, and a metal salt of at least one phosphoric acid selected from the group consisting of phosphoric acid, phosphorous acid, and hypophosphorous acid.

The phosphoric acid contained in the lightfastness improver of the present invention is preferably a sodium salt of phosphoric acid, from the viewpoint that the film has further excellent lightfastness.

### Chelating Agent Containing Phosphorus

The chelating agent containing phosphorus contained in the lightfastness improver of the present invention is preferably at least one chelating agent selected from the group consisting of an inorganic chelating agent and an organic chelating agent.

Among the above chelating agents containing phosphorus, the inorganic chelating agent containing phosphorus is not particularly limited. Preferred examples of the inorganic chelating agent containing phosphorus include pyrophosphoric acid and salts thereof, polyphosphoric acid and salts thereof, hexametaphosphoric acid and salts thereof, metaphosphoric acid and salts thereof, tripolyphosphoric acid and salts thereof, tetrapolyphosphoric acid and salts thereof, and the like.

The salt of the inorganic chelating agent containing phosphorus is not particularly limited, and is at least one salt selected from the group consisting of a lithium salt, a sodium salt, a potassium salt, an ammonium salt, an alkaline earth metal salt, and a metal salt.

Among the above chelating agents containing phosphorus, the organic chelating agent containing phosphorus is not particularly limited. Preferred examples of the organic chelating agent containing phosphorus include aminotrimethylene phosphonic acid and salts thereof, hydroxyethylidene diphosphonic acid and salts thereof, nitrilotrismethylenephosphonic acid and salts thereof, phosphonobutane tricarboxylic acid and salts thereof, ethylenediamine tetramethylenephosphonic acid and salts thereof, diethylenetriaminepentamethylenephosphonic acid and salts thereof, vinylphosphonic acid and salts thereof, phenyl phosphoric acid and salts thereof, β-glycerophosphoric acid and salts thereof, DL-2-aminophosphonobutyric acid and salts thereof, diphenylphosphonic acid and salts thereof, aminomethylphosphonic acid and salts thereof, phosphonoformic acid and salts thereof, and the like.

The salt of the organic chelating agent containing phosphorus is not particularly limited, and is at least one salt selected from the group consisting of a lithium salt, a sodium salt, a potassium salt, an ammonium salt, an alkaline earth metal salt, and a metal salt thereof.

The chelating agent containing phosphorus contained in the lightfastness improver of the present invention is preferably nitrilotrismethylenephosphonic acid or a sodium salt thereof, or phosphonobutane tricarboxylic acid or a sodium salt thereof, from the viewpoint that the film has further excellent lightfastness.

In the lightfastness improver of the present invention, at least one phosphorus compound selected from the group consisting of a phosphoric acid, a phosphate, and a chelating agent containing phosphorus can be used singly or as a mixture of two or more thereof.

### Content of Phosphorus Compound

The content of the phosphorus compound in the lightfastness improver of the present invention is preferably 1 mg/L to 5,000 mg/L, and more preferably 10 mg/L to 200 mg/L.

The lightfastness can be further improved by adjusting the content of the phosphorus compound to preferably 1 mg/L or more. The lightfastness can be further improved by adjusting the content of the phosphorus compound to preferably 5,000 mg/L or less.

The lightfastness improver of the present invention is excellent, for example, in that it is possible to suppress color loss of the film during surface treatment and suppress powdering on the surface of the anodic oxide film and fogging appearance defects by setting the content of the phosphorus compound within the above preferred range.

### PH

The pH of the lightfastness improver of the present invention is preferably 2 to 9, and more preferably 4 to 7.

By adjusting the pH of the lightfastness improver to preferably 4 or more, the lightfastness can be further improved, and at the same time, a uniform dyed appearance without unevenness can be obtained. By adjusting the pH of the lightfastness improver to preferably 7 or less, the lightfastness can be further improved, and at the same time, color loss due to detachment of the dye can be suppressed, and a uniform dyed appearance can be obtained.

### Aqueous Solution

The lightfastness improver of the present invention is preferably an aqueous solution.

### Other Components

The lightfastness improver of the present invention preferably contains additive components, such as a pH buffer, a pH adjuster, a surfactant, and an antifungal agent, as necessary, for the purpose of further improving lightfastness during surface treatment and further improving the practicality of use of the lightfastness improver.

Preferred examples of additives include antifungal agents, such as benzoic acid and benzoate. As the antifungal agent, a commercially available antifungal agent, such as TAC Kabikoron (produced by Okuno Chemical Industries Co., Ltd.), is preferably used.

### Dyeing Solution

The lightfastness improver of the present invention preferably further contains a dye. The lightfastness improver of the present invention is preferably used as a dyeing solution.

### Dyeing Pretreatment Agent

The lightfastness improver of the present invention is preferably a pretreatment agent used in pretreatment of dyeing using a dye. The lightfastness improver of the present invention is preferably used as a dyeing pretreatment agent.

### Dyeing Post-Treatment Agent

The lightfastness improver of the present invention is preferably a post-treatment agent used in post-treatment of dyeing using a dye. The lightfastness improver of the present invention is preferably used as a dyeing post-treatment agent.

### Dye

The dye used for dyeing to which the lightfastness improver of the present invention is applied is preferably an organic dye.

The organic dye is not particularly limited, and is preferably an azo organic dye, a metal complex-type azo organic dye, an anthraquinone organic dye, a phthalocyanine organic dye, a xanthene organic dye, or a quinoline organic dye.

### Film

The film to which the lightfastness improver of the present invention is applied is an anodic oxide film of aluminum or an aluminum alloy, or a dyed anodic oxide film of aluminum or an aluminum alloy.

### (2) Method for Improving Lightfastness of Film

The present invention is a method for improving the lightfastness of a film.

The film is a dyed anodic oxide film of aluminum or an aluminum alloy.

The method for improving the lightfastness of a film according to the present invention comprises:

(1) immersing a film in a lightfastness improver comprising at least one phosphorus compound selected from the group consisting of a phosphoric acid, a phosphate, and a chelating agent containing phosphorus.

### When Lightfastness Improver of the Present Invention Is Added to Dyeing Bath

The method for improving the lightfastness of a film according to the present invention preferably comprises:

(1) immersing a film in a lightfastness improver comprising at least one phosphorus compound selected from the group consisting of a phosphoric acid, a phosphate, and a chelating agent containing phosphorus, and further comprising a dye.

The method for improving the lightfastness of a film according to the present invention exhibits the function of a dyeing solution.

The method for improving the lightfastness of a film according to the present invention comprises immersing (dyeing) the film in a lightfastness improver (dyeing bath) containing the phosphorus compound and further a dye, whereby the lightfastness of the film is improved.

In the method for improving the lightfastness of a film according to the present invention, the film is preferably subjected to, in sequence, pretreatment, anodization treatment, dyeing treatment with a dyeing bath containing the lightfastness improver and a dye, and sealing treatment.

### When Lightfastness Improver of the Present Invention is Applied Before Dyeing

The method for improving the lightfastness of a film according to the present invention preferably comprises:

(1) immersing a film in a lightfastness improver comprising at least one phosphorus compound selected from the group consisting of a phosphoric acid, a phosphate, and a chelating agent containing phosphorus; and

(2) dyeing the film obtained in step (1).

The method for improving the lightfastness of a film according to the present invention exhibits the function of a pretreatment agent used in pretreatment of dyeing using a dye.

The method for improving the lightfastness of a film according to the present invention comprises immersing the film in a solution in which the phosphorus compound is dissolved, before the dyeing treatment of the film, whereby this step serves as lightfastness improvement treatment, and the lightfastness of the film is improved.

In the method for improving the lightfastness of a film according to the present invention, the film is preferably subjected to, in sequence, pretreatment, anodization treatment, lightfastness improvement treatment, dyeing treatment with a dyeing bath containing a dye, and sealing treatment.

When Lightfastness Improver of the Present Invention is Applied after Dyeing

The method for improving the lightfastness of a film according to the present invention preferably comprises:

(1) dyeing a film; and

(2) immersing the film obtained in step (1) in a lightfastness improver comprising at least one phosphorus compound selected from the group consisting of a phosphoric acid, a phosphate, and a chelating agent containing phosphorus.

The method for improving the lightfastness of a film according to the present invention exhibits the function of a post-treatment agent used in post-treatment of dyeing using a dye.

The method for improving the lightfastness of a film according to the present invention comprises immersing the film in a solution in which the phosphorus compound is dissolved, after the dyeing treatment of the film, whereby this step serves as lightfastness improvement treatment, and the lightfastness of the film is improved.

In the method for improving the lightfastness of a film according to the present invention, the film is preferably subjected to, in sequence, pretreatment, anodization treatment, dyeing treatment using a dyeing bath containing a dye, lightfastness improvement treatment, and sealing treatment.

The content described in the above section of the lightfastness improver is applied to the phosphorus compound, dye, and the like contained in the lightfastness improver.

### Anodization Treatment

In the method for improving the lightfastness of a film according to the present invention, this is a step of forming an anodic oxide film on aluminum or an aluminum alloy.

The anodization treatment may be preferably performed by applying a conventionally known method, and anodization is performed by immersing aluminum or an aluminum alloy, which is an object to be treated, in an anodization treatment solution.

The electrolyte used in the anodization treatment is not particularly limited, and is preferably, for example, a sulfuric acid aqueous solution electrolyte, an oxalic acid aqueous solution electrolyte, a chromic acid aqueous solution electrolyte, or a sulfonic acid aqueous solution electrolyte. The liquid temperature of the electrolyte (treatment solution) is preferably, for example, about 0° C. to 80° C., and more preferably about 10° C. to 40° C.

The electrolysis method may be AC or DC. The electrolysis method is preferably DC electrolysis because film formation is fast and a thick film can be easily obtained.

The current density is, for example, about 0.1 A/dm² to A/dm², and preferably about 0.5 to 3 A/dm². The energization time is generally about 10 minutes to 100 minutes.

The thickness of the film formed by anodization is preferably about 2 μm to 50 μm, and more preferably about 5 μm to 20 μm, and is set to any thickness depending on the application.

Before performing the anodization treatment, first, aluminum or an aluminum alloy to be treated is pretreated to remove deposits. The pretreatment method is not particularly limited. Preferably, a known treatment method, such as solvent cleaning, acid cleaning, weak alkali cleaning, acid etching, alkali etching, desmutting, or chemical polishing, is appropriately applied depending on the type of material and the state of deposits.

After the anodization treatment is performed on aluminum or an aluminum alloy, dyeing is performed using a dyeing solution or a dyeing solution containing the lightfastness improver of the present invention. Alternatively, after treatment with a dyeing pretreatment agent containing the lightfastness improver of the present invention, dyeing is performed using a dyeing solution.

### Dyeing Treatment

In the method for improving the lightfastness of a film according to the present invention, this is a step of subjecting a film to dyeing treatment. The film is preferably an anodic oxide film of aluminum or an aluminum alloy.

The film, preferably an anodic oxide film of aluminum or an aluminum alloy, to be subjected to dyeing treatment may be an anodic oxide film obtained by applying a known anodization method using sulfuric acid, oxalic acid, or the like to general aluminum or an aluminum alloy.

The aluminum alloy is not particularly limited, and various aluminum-based alloys can be subjected to anodization. Specifically, the aluminum alloy is preferably a group of various aluminum-based alloys typified by wrought material alloys represented by JIS-A 1,000 to 7,000 series, and cast materials and die-cast materials represented by AC, ADC, etc., specified in JIS.

The dyeing treatment is not particularly limited, and examples include coloring with a dye. Examples of coloring with a dye include a method of immersing an anodic oxide film in a conventionally known dye aqueous solution. The dye preferably used is a dye commercially available as a dye for an anodic oxide film of aluminum or an aluminum alloy. The dye preferably used is, for example, an anionic dye.

For dyeing, an aqueous solution containing a dye (dyeing bath, dyeing solution, etc.) is preferably used.

The temperature of the dye-containing aqueous solution is preferably 10° C. to 70° C., and more preferably 20° C. to 60° C.

The concentration of the dye in the dye-containing aqueous solution and the immersion time can be appropriately set depending on the desired color tone and color density of dyeing.

By the dyeing treatment described above, the anodic oxide film of aluminum or an aluminum alloy is subjected to dyeing treatment.

### Lightfastness Improvement Treatment

In the method for improving the lightfastness of a film according to the present invention, this is a step of improving the lightfastness of a dyed anodic oxide film of aluminum or an aluminum alloy.

The lightfastness improvement treatment is a step of performing surface treatment by immersion in the lightfastness improver comprising a phosphorus compound of the present invention.

As described above, in the lightfastness improvement treatment, the lightfastness improver of the present invention is preferably added to a dyeing bath containing a dye (the lightfastness improver containing a dye), applied before dyeing treatment using a dyeing bath containing a dye, and/or applied after dyeing treatment using a dyeing bath containing a dye.

According to the method for improving the lightfastness of a film according to the present invention, the lightfastness of the film is improved by the lightfastness improvement treatment.

### When Lightfastness Improver Contains Dye

When the lightfastness improver contains a dye, the temperature of the lightfastness improver is preferably 10° C. to 80° C., and more preferably 20° C. to 60° C. By adjusting the temperature of the lightfastness improver within the above range, the lightfastness can be further improved.

The immersion time is not particularly limited, and is preferably 30 seconds to 30 minutes, and more preferably 1 minute to 10 minutes. The immersion time for obtaining the target color tone is appropriately set. By adjusting the immersion time within the above range, the lightfastness of the anodic oxide film can be further improved within a range in which excellent production efficiency can be achieved.

### When Lightfastness Improver is Applied Before Dyeing Treatment

When the lightfastness improver is applied before dyeing treatment, the temperature of the lightfastness improver is preferably 10° C. to 80° C., and more preferably 20° C. to 60° C. By adjusting the temperature of the lightfastness improver within the above range, the lightfastness can be further improved.

The immersion time is preferably 30 seconds to 30 minutes, and more preferably 1 minute to 10 minuets. By adjusting the immersion time within the above range, the lightfastness of the anodic oxide film can be further improved within a range in which excellent production efficiency can be achieved.

After the lightfastness improvement treatment is performed, the film is washed with water and immersed in the dyeing solution of the next step to dye the film. In this case, washing with water between the lightfastness improvement treatment and the dyeing treatment can be omitted.

When Lightfastness Improver is Applied after Dyeing Treatment

When the lightfastness improver is applied after dyeing treatment, after the dyeing treatment, the dyed film is sufficiently washed with water and then immersed in the lightfastness improver of the present invention.

The temperature of the lightfastness improver is preferably 10° C. to 80° C., and more preferably 20° C. to 60° C. By adjusting the temperature of the lightfastness improver within the above range, the lightfastness can be further improved.

The immersion time is preferably 30 seconds to 30 minutes, and more preferably 1 minute to 10 minutes. By adjusting the immersion time within the above range, the lightfastness of the anodic oxide film can be further improved within a range in which excellent production efficiency can be achieved.

By the lightfastness improvement treatment described above, the film is subjected to lightfastness improvement treatment.

### (3) Sealing Treatment Method

In the method for improving the lightfastness of a film according to the present invention, the film is preferably subjected to pretreatment, anodization treatment, dyeing treatment with a dyeing bath containing a dye, lightfastness improvement treatment, and the like, preferably followed by sealing treatment.

The sealing treatment method is a step of subjecting the film surface-treated by the lightfastness improvement treatment to sealing treatment. The film is preferably an anodic oxide film of aluminum or an aluminum alloy.

The sealing treatment is not particularly limited, and is preferably performed by a conventionally known sealing treatment method. In the sealing treatment method, the film (preferably an anodic oxide film of aluminum or an aluminum alloy) surface-treated by the lightfastness improvement treatment is preferably immersed in a sealing treatment solution.

The sealing treatment solution is not particularly limited, and is preferably a sealing treatment solution containing a metal salt. The metal contained in the metal salt is preferably an alkali metal, an alkaline earth metal, a transition metal, or the like. Specifically, the metal is preferably Li, Be, Na, Mg, K, Ca, Rb, Sr, Cs, Ba, Fr, Ra, Zr, Mn, Fe, Ni, Co, or the like. Preferred among these metal salts are metal salts of Na, Mg, K, Ca, Ba, Mn, Ni, etc., and more preferred are metal salts of Mg, Ca, Mn, and Ni, from the viewpoint that the film subjected to sealing treatment (preferably an anodic oxide film of aluminum or an aluminum alloy) has excellent corrosion resistance.

In the sealing treatment solution, these metal salts can be used singly or as a mixture of two or more thereof.

The concentration of the metal salt in the sealing treatment solution is not particularly limited, and is preferably 0.001 mol/L to 1 mol/L, and more preferably 0.003 mol/L to 0.3 mol/L. By adjusting the concentration of the metal salt in the sealing treatment solution within the above range, the sealing treatment solution can exhibit sufficient sealing performance, and the corrosion resistance of the film subjected to sealing treatment with the sealing treatment solution can be further improved.

The sealing treatment solution preferably further contains additive components, such as a pH buffer and a surfactant, for the purpose of improving sealing performance (appearance, corrosion resistance, etc.). Examples of additives include pH buffers or pH adjusters, such as acetic acid, acetate, nitric acid, nitrate, benzoic acid, and benzoate; sulfonic acid dispersants, such as sodium salts of naphthalene sulfonic acid formalin condensates; and the like.

The pH of the sealing treatment solution is preferably 5.0 to 8.0, and more preferably 5.3 to 6.0. The pH of the sealing treatment solution is preferably adjusted to the above range using, for example, an acid, such as acetic acid, nitric acid, benzoic acid, or sulfuric acid; or an alkali, such as sodium hydroxide, sodium carbonate, or ammonia water.

The temperature of the sealing treatment solution (treatment temperature) is preferably 80° C. to the boiling point, and more preferably 85° C. to the boiling point.

The immersion time in the sealing treatment solution is preferably about 1 minute to 60 minutes, and more preferably about 3 minutes to 30 minutes.

By adjusting the treatment temperature and the immersion time using the sealing treatment solution within the above ranges, it is possible to prevent powdering of the film after sealing, improve the contamination resistance of the film, and obtain corrosion resistance.

The sealing treatment solution preferably contains additive components, such as an antifungal agent, as necessary, for the purpose of improving sealing performance and the practicality of use of the solution. Preferred examples of additives include antifungal agents, such as benzoic acid and benzoate. As the antifungal agent, a commercially available antifungal agent, such as TAC Kabikoron (produced by Okuno Chemical Industries Co., Ltd.), is preferably used.

The sealing treatment solution preferably contains the above metal salt, a pH buffer, a surfactant, and the like, and other components are not particularly limited and preferably include an aqueous solution.

According to the sealing treatment method described above, the film is subjected to surface treatment by the lightfastness improvement treatment. In addition, discoloration of the film after sealing treatment when irradiated with light can be suppressed, and excellent lightfastness can be exhibited.

The method for improving the lightfastness of a film according to the present invention is excellent, for example, in that powdering on the surface of the anodic oxide film and fogging appearance defects can be suppressed during surface treatment by setting the preferable conditions within the above ranges.

### (4) Article

An article obtained by applying the lightfastness improver of the present invention, and an article obtained by applying the method for improving the lightfastness of a film of the present invention, preferably have a dyed anodic oxide film of aluminum or an aluminum alloy subjected to sealing treatment by the sealing treatment method described above.

Since the article has a dyed anodic oxide film of aluminum or an aluminum alloy subjected to sealing treatment by the sealing treatment, its application is not particularly limited, and preferred examples include exteriors of electronic devices, exteriors of cosmetic products, and the like.

According to the article of the present invention, since the anodic oxide film of aluminum or an aluminum alloy surface-treated by the lightfastness improvement treatment is subjected to sealing treatment by the sealing treatment method, the anodic oxide film of the article has excellent dyeing fastness. In addition, discoloration of the anodic oxide film of the article when irradiated with light can be suppressed, and excellent lightfastness can be exhibited.

The use of the lightfastness improver of the present invention can improve the lightfastness of the film as surface treatment of the film.

According to the present invention, since the lightfastness of the film can be improved, discoloration of the film after sealing treatment when irradiated with light can be suppressed, and excellent lightfastness can be exhibited.

According to the present invention, since the lightfastness of the film can be improved and sealing treatment is preferably performed, discoloration of the film of the obtained article when irradiated with light can be suppressed, and the article can exhibit excellent lightfastness.

The dyeing is preferably dyeing with an organic dye.

The present invention is a surface treatment technique capable of suppressing discoloration of an anodic oxide film or the like of aluminum, an aluminum alloy, or the like that has been subjected to dyeing treatment with a dye, improving lightfastness, and maintaining designability. The present invention is a surface treatment method that does not necessarily include a halogen compound, nitric acid nitrogen, or the like, and is a surface treatment technique that can reduce the use of environmentally hazardous substances.

### EXAMPLES

The present invention is described in detail below with reference to Examples and Comparative Examples. However, the present invention is not limited to the Examples.

According to the following production conditions, aluminum alloy test pieces subjected to anodization treatment and dyeing treatment for use in the following Examples and Comparative Examples were produced.

### Anodization Treatment

An aluminum alloy test piece (JIS A1050P plate) was immersed in a weak alkaline degreasing solution (an aqueous solution of 30 g/L of Top Alclean 404 (trade name), produced by Okuno Chemical Industries Co., Ltd., bath temperature: 60° C.) for 5 minutes for degreasing.

Next, the degreased aluminum alloy test piece was washed with water, and the washed aluminum alloy test piece was subjected to anodization treatment (bath temperature: 20° C.±1° C., anodic current density: 1 A/dm², electrolysis time: 30 minutes, film thickness: about 10 μm) using an anodization bath containing sulfuric acid as a main component (containing 180 g/L of free sulfuric acid and 8.0 g/L of dissolved aluminum).

### Dyeing Treatment

Next, the obtained anodic oxide film was washed with water, and after washing with water, dyed by being immersed in a dyeing solution (aqueous solution) (bath temperature: 55° C.) containing the following dye for 1 minute, followed by washing with water, thereby obtaining an aluminum alloy test piece subjected to anodization and dyeing.

The dye used for dyeing is TAC dye, TAC BLACK-GRLH (420) or TAC BLACK-GRLH (402), produced by Okuno Chemical Industries Co., Ltd.

### Lightfastness Test Method

Tester: Suntest XLS+(produced by Atlas), light source: xenon lamp
Radiation intensity: 550 W/m², irradiation temperature: 65° C.
Irradiation time: 0 hr, 25 hr, 50 hr, 100 hr, and 300 hr
Color difference measurement: integrating sphere
spectrophotometer SP-64 (produced by X-rite)
Color difference measurement items: ΔL* Δa* Δb* ΔE*ab

Using the lightfastness test time of 0 hr as a reference, the color difference after the test was confirmed.

The smaller ΔE*ab is, the better the lightfastness of the film is.

$$Δ {E}^{*} ab = √ \{ {( Δ {L}^{⋆} )}^{2} + {( Δ {a}^{⋆} )}^{2} + {( Δ {b}^{⋆} )}^{2} \}$$

### Examples and Comparative Examples in Tables 1 and 2

These tables show the lightfastness test results in the case in which the lightfastness improver of the present invention was added to the dyeing solution.

TAC BLACK-GRLH (420) was used as the dye in the dyeing bath, and the dyeing treatment was performed at a pH of 5.5 and 55° C. while changing the dye concentration and immersion time so as to obtain the same degree of color tone.

### Table 1: Phosphate

In Comparative Example 1, dyeing was performed using a dyeing bath containing the dye alone.

In Comparative Example 2, dyeing was performed using a dyeing bath containing a phosphorus-free inorganic salt.

In Examples 1 and 2, dyeing was performed using a dyeing bath containing phosphate.

### Table 2: Chelating Agent Containing Phosphorus

In Comparative Examples 3, 4, and 5, dyeing was performed using a dyeing bath containing a phosphorus-free chelating agent.

In Examples 3 to 9, dyeing was performed using a dyeing bath containing a phosphorus-containing chelating agent.

### Examples and Comparative Examples in Table 3

This table shows the lightfastness test results in the case in which the lightfastness improvement treatment of the present invention was performed before and after dyeing treatment.

In Comparative Example 6, dyeing was performed using a dyeing bath containing the dye alone.

In Example 10, 25 mg/L of hydroxyethylidene diphosphonic acid was added to the dyeing solution as a phosphorus-containing chelating agent.

In Example 11, the lightfastness improvement treatment was performed before dyeing.

In Example 12, the lightfastness improvement treatment was performed after dyeing.

In both Examples 11 and 12, an aqueous solution of 25 mg/L of hydroxyethylidene diphosphonic acid was used as a phosphorus-containing chelating agent at a pH 5.5 and 55° C. for 2 minutes in the lightfastness improvement treatment. The dyeing treatment was performed using TAC BLACK-GLH (402) at 2 g/L and 55° C. while changing the immersion time so as to obtain the same degree of color tone.

As shown in the lightfastness test results in Tables 1 to 3, the present invention is excellent in that the use of the lightfastness improver of the present invention can improve the lightfastness of the anodic oxide film of aluminum or an aluminum alloy.

TABLE 1
(dyeing solution: phosphate)

| | | Color difference | | | | | | | | | | |
|---|---|---|---|---|---|---|---|---|---|---|---|---|
| System of | Additive to | Lightfastness test 0 h | | | Lightfastness test 25 h | | | | Lightfastness test 50 h | | | |
| additive | dyeing solution | L* | a* | b* | [symbol] L* | [symbol] a* | [symbol] b* | [symbol] E*ab | [symbol] L* | [symbol] a* | [symbol] b* | [symbol] E*ab |
| Comparative | None | 52.90 | 1.47 | 2.60 | 3.63 | −0.49 | 1.82 | 4.09 | 6.72 | −0.56 | 2.29 | 7.12 |
| Example 1 | | | | | | | | | | | | |
| standard | | | | | | | | | | | | |
| Comparative | Sodium sulfate | 54.05 | 2.77 | 5.16 | 6.58 | −0.17 | 3.33 | 7.38 | 10.28 | −0.09 | 4.09 | 11.06 |
| Example 2 | 2 g/L | | | | | | | | | | | |
| inorganic salt | | | | | | | | | | | | |
| Example 1 | Trisodium | 64.93 | 0.61 | 1.85 | 1.07 | −0.24 | 0.89 | 1.41 | 1.72 | −0.39 | 0.84 | 1.95 |
| phosphate | phosphate | | | | | | | | | | | |
| | 15 mg/L | | | | | | | | | | | |
| Example 2 | Sodium | 53.40 | 1.35 | 2.26 | 1.39 | −0.35 | 1.05 | 1.78 | 1.82 | −0.52 | 1.16 | 2.22 |
| phosphate | hypophosphite | | | | | | | | | | | |
| | 10 mg/L | | | | | | | | | | | |

TABLE 2
(dyeing solution: phosphorus-containing chelating agent)

| | | Color difference | | | | | | | | | | |
|---|---|---|---|---|---|---|---|---|---|---|---|---|
| System of | Additive to | Lightfastness test 0 h | | | Lightfastness test 25 h | | | | Lightfastness test 50 h | | | |
| additive | dyeing solution | L* | a* | b* | [symbol] L* | [symbol] a* | [symbol] b* | [symbol] E*ab | [symbol] L* | [symbol] a* | [symbol] b* | [symbol] E*ab |
| Comparative | Disodium | 53.39 | 1.41 | 3.71 | 2.37 | 0.13 | 1.05 | 2.60 | 3.85 | 0.29 | 1.26 | 4.06 |
| Example 3 | ethylenediamine- | | | | | | | | | | | |
| chelating agent | tetraacetate 1 g/L | | | | | | | | | | | |
| Comparative | Citric acid | 57.75 | 1.11 | 2.75 | 4.70 | −0.12 | 1.53 | 4.94 | 6.60 | −0.02 | 2.04 | 6.91 |
| Example 4 | 0.1 g/L | | | | | | | | | | | |
| chelating agent | | | | | | | | | | | | |
| Comparative | Malonic acid | 52.30 | 1.99 | 4.40 | 3.98 | −0.13 | 1.34 | 4.20 | 5.03 | −0.08 | 1.52 | 5.26 |
| Example 5 | 0.1 g/L | | | | | | | | | | | |
| chelating agent | | | | | | | | | | | | |
| Example 3 | Tripolyphosphoric | 54.37 | 1.44 | 2.00 | 1.18 | −0.22 | 0.68 | 1.38 | 1.63 | −0.41 | 1.26 | 2.10 |
| phosphorus- | acid 15 mg/L | | | | | | | | | | | |
| containing | | | | | | | | | | | | |
| chelating agent | | | | | | | | | | | | |
| Example 4 | Pyrophosphoric acid | 55.21 | 1.38 | 2.31 | 1.34 | −0.18 | 0.67 | 1.51 | 2.47 | −0.39 | 1.00 | 2.69 |
| phosphorus- | 15 mg/L | | | | | | | | | | | |
| containing | | | | | | | | | | | | |
| chelating agent | | | | | | | | | | | | |
| Example 5 | Hydroxyethylidene | 53.40 | 1.35 | 2.26 | 1.13 | −0.38 | 0.96 | 1.53 | 1.70 | −0.54 | 0.82 | 1.96 |
| phosphorus- | diphosphonic acid | | | | | | | | | | | |
| containing | 100 mg/L | | | | | | | | | | | |
| chelating agent | | | | | | | | | | | | |
| Example 6 | Nitrilotris- | 49.70 | 1.27 | 2.17 | 0.73 | −0.36 | 0.77 | 1.12 | 1.24 | −0.52 | 0.63 | 1.48 |
| phosphorus- | methylenephosphonic | | | | | | | | | | | |
| containing | acid 100 mg/L | | | | | | | | | | | |
| chelating agent | | | | | | | | | | | | |
| Example 7 | Phosphonobutane | 51.11 | 1.06 | 2.27 | 1.33 | −0.39 | 0.87 | 1.64 | 1.87 | −0.57 | 0.66 | 2.06 |
| phosphorus- | tricarboxylic acid | | | | | | | | | | | |
| containing | 100 mg/L | | | | | | | | | | | |
| chelating agent | | | | | | | | | | | | |
| Example 8 | Ethylenediamine | 47.68 | 1.17 | 2.59 | 1.07 | −0.45 | 0.88 | 1.46 | 1.70 | −0.62 | 0.73 | 1.95 |
| phosphorus- | tetramethylene | | | | | | | | | | | |
| containing | phosphonic acid | | | | | | | | | | | |
| chelating agent | 90 mg/L | | | | | | | | | | | |
| Example 9 | Diethylenetriamine | 70.91 | 1.13 | 2.06 | 1.63 | −0.34 | 1.08 | 1.98 | 2.25 | −0.46 | 0.93 | 2.48 |
| phosphorus- | pentamethylene | | | | | | | | | | | |
| containing | phosphonic acid- | | | | | | | | | | | |
| chelating agent | 7Na 250 mg/L | | | | | | | | | | | |

| | Color difference | | | | | | | | | | |
|---|---|---|---|---|---|---|---|---|---|---|---|
| Lightfastness | Lightfastness test 0 h | | | Lightfastness test 100 h | | | | Lightfastness test 300 h | | | |
| improvement treatment | L* | a* | b* | [symbol] L* | [symbol] a* | [symbol] b* | [symbol] E*ab | [symbol] L* | [symbol] a* | [symbol] b* | [symbol] E*ab |
| Comparative Example 6 | 38.93 | 0.97 | 4.58 | 3.46 | −0.08 | −1.46 | 3.76 | 12.07 | 0.24 | −2.07 | 12.25 |
| standard | | | | | | | | | | | |
| Example 10 | 38.68 | 1.05 | 4.38 | 1.39 | −1.31 | −0.67 | 2.02 | 3.85 | −1.89 | −1.53 | 4.55 |
| added to dyeing solution | | | | | | | | | | | |
| Example 11 | 38.62 | 0.85 | 4.26 | 2.65 | −1.07 | −1.02 | 3.03 | 5.19 | −1.46 | −1.74 | 5.67 |
| before dyeing | | | | | | | | | | | |
| Example 12 | 38.15 | 1.00 | 4.31 | 2.28 | −0.92 | −1.06 | 2.68 | 5.11 | −1.47 | −1.65 | 5.57 |
| after dyeing | | | | | | | | | | | |

1. A lightfastness improver for a film,
the film being a dyed anodic oxide film of aluminum or an aluminum alloy, and
the lightfastness improver comprising at least one phosphorus compound selected from the group consisting of a phosphoric acid, a phosphate, and a chelating agent containing phosphorus.

2. The lightfastness improver according to claim 1, wherein the phosphoric acid is at least one phosphoric acid selected from the group consisting of phosphoric acid, phosphorous acid, and hypophosphorous acid.

3. The lightfastness improver according to claim 1, wherein the phosphate is at least one salt selected from the group consisting of a sodium salt, a potassium salt, an ammonium salt, an alkaline earth metal salt, and a metal salt of at least one phosphoric acid selected from the group consisting of phosphoric acid, phosphorous acid, and hypophosphorous acid.

4. The lightfastness improver according to claim 1, wherein the chelating agent containing phosphorus is at least one chelating agent selected from the group consisting of an inorganic chelating agent and an organic chelating agent.

5. The lightfastness improver according to claim 1, wherein the phosphorus compound is contained in an amount of 1 mg/L to 5,000 mg/L.

6. The lightfastness improver according to claim 1, further comprising a dye.

7. The lightfastness improver according to claim 1, which is a pretreatment agent for dyeing using a dye.

8. The lightfastness improver according to claim 1, which is a post-treatment agent for dyeing using a dye.

9. The lightfastness improver according to claim 1, wherein the dye is an organic dye.

10. A method for improving the lightfastness of a film, the film being a dyed anodic oxide film of aluminum or an aluminum alloy, and the method comprising:
(1) immersing the film in a lightfastness improver comprising at least one phosphorus compound selected from the group consisting of a phosphoric acid, a phosphate, and a chelating agent containing phosphorus.

11. A method for improving the lightfastness of a film, the film being a dyed anodic oxide film of aluminum or an aluminum alloy, and the method comprising:
(1) immersing the film in a lightfastness improver comprising at least one phosphorus compound selected from the group consisting of a phosphoric acid, a phosphate, and a chelating agent containing phosphorus, and further comprising a dye.

12. A method for improving the lightfastness of a film, the film being a dyed anodic oxide film of aluminum or an aluminum alloy, and the method comprising:
(1) immersing the film in a lightfastness improver comprising at least one phosphorus compound selected from the group consisting of a phosphoric acid, a phosphate, and a chelating agent containing phosphorus; and
(2) dyeing the film obtained in step (1).

13. A method for improving the lightfastness of a film, the film being a dyed anodic oxide film of aluminum or an aluminum alloy, and the method comprising:
(1) dyeing the film; and
(2) immersing the film obtained in step (1) in a lightfastness improver comprising at least one phosphorus compound selected from the group consisting of a phosphoric acid, a phosphate, and a chelating agent containing phosphorus.
